(19) United States
(12) Patent Application Publication
(10) Pub. No.: US 2010/0284350 A1
(43) Pub. Date: Nov. 11, 2010

(54) APPARATUS, METHOD AND COMPUTER PROGRAM PRODUCT PROVIDING FLEXIBLE PREAMBLE SEQUENCE ALLOCATION

(75) Inventors: Juha Sakari Korhonen, Espoo (FI); Kari Juhani Hooli, Oulu (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/663,507

(22) PCT Filed: Jun. 5, 2008
(86) PCT No.: PCT/IB08/52224

§ 371 Date: Jun. 14, 2010

Related U.S. Application Data
(60) Provisional application No. 60/933,732, filed on Jun. 7, 2007.

(51) Int. Cl. H04W 72/00

(52) U.S. Cl. 370/329

(57) ABSTRACT

An access node/base station is allocated one or more root sequences for use with RACH preambles in the cell. The access node broadcasts an index for one of the root sequences and a basic cyclic shift parameter. A user equipment UE receives the index and parameter, determines all of the root sequences that are allocated to the cell (directly from the index and inherently from it if more than one root is allocated), and selects a sequence from among all cyclic shifts (including zero shift) of all of the allocated root sequences. The access node is required to make available in the cell a predetermined minimum number of cyclic shifts, but by selecting its sequence from among all cyclic shifts of all allocated root sequences, the UE's selection is not limited to be from among that minimum number. The UE sends on the RACH a preamble signal with the selected sequence.

### TECHNICAL FIELD

The exemplary and non-limiting embodiments of this invention relate generally to wireless communications systems and, more specifically, relate to allocation of and transmissions/receptions with preamble signals such as Zadoff-Chu sequences, including their roots and cyclic shifts.

### BACKGROUND

Various abbreviations that appear in the specification and/or in the drawing figures are defined as follows:

3GPP third generation partnership project

CAZAC constant amplitude zero auto-correlation

DFT discrete Fourier transform

e- evolved (also known as LTE)

FDM/FDMA frequency division multiplex/multiple access

IDFT inverse DFT

IFFT inverse fast Fourier transform

LTE long term evolution (also known as 3.9G)

Node B base station or BS

OFDM orthogonal frequency division multiplex

RACH random access channel

RAN radio access network

UE user equipment

UL uplink

UMTS universal mobile telecommunications system

UTRAN UMTS terrestrial radio access network

ZC Zadoff-Chu

Preambles on a LTE RACH are described on a general level in 3GPP TS 36.211 v. 1.0.0. The preambles are Zadoff-Chu sequences. The length N_{zc} of the sequences is 839. There are N_{zc}−1 root sequences (the equation for the root sequences can be found from 3GPP 36.211, v. 1.1.0.), and in addition, typically several cyclic shifts of each root sequence are available. The cyclic shifts are defined as S_{k,v}(n)=S_{k,0}(mod(n+v*N_{cs},N_{zc})), where k is the index of the root sequence, v=0, . . . , floor(N_{zc}/N_{cs}) is the index of a cyclic shift, N_{cs} is a parameter determining the cyclic shift increment, and n=0, . . . , N_{zc}−1 is the index of the samples in a sequence.

The number of cyclic shifts (range of parameter v) depends on the cell size: N_{cs} must correspond to delay that is larger than the expected maximum two-way propagation delay in the cell. (The length of the preamble of 839 samples is 0.8 ms. If the maximum expected propagation delay over both the downlink and uplink is Tₚᵣₒₚ, N_{cs} must be larger than 839*Tₚᵣₒₚ/0.8 ms.) The equation above is written for the normal case of cells with only slowly moving UEs. In case of cells with high mobility UEs, the cyclic shifts are not necessarily obtained with the simple equation above but the number of available cyclic shifts per root index becomes dependent on k, see 3GPP R1-072626. In any case, there is a set of root sequences and their cyclically shifted sequences that should be divided between the cells.

It has been agreed in 3GPP that the number of sequences is 64 per cell (see FIGS. 1A-1B for the RACH preamble format and how it is generated). There are two competing concerns in arriving at this or any different such allocation. With respect to the preamble collision probability, this number should be as large as possible. With respect to processing in the receiver at the e-Node B that receives the RACH transmissions, this number should be reasonably small.

Low preamble collision probability is important because if more than two UEs send the same sequence, also the UE transmissions following the preamble acknowledgements are colliding, which means reduced probability of successful random access procedure and additional delays. Generally, most would agree that an acceptable preamble collision probability is around 1%, meaning that when UE sends a preamble, the probability that at least one other UE is sending the same preamble sequence is 1%. The customary approach for modeling traffic on the RACH is to assume that access attempts are Poisson distributed. If the number of sequences is N_seq and the preamble transmissions are Poisson distributed with the mean rate N_pre (per time and frequency resource reserved for RACH), the collision probability is roughly N_pre/N_seq.

The natural way of allocating sequences is that different root sequences are used in the neighboring cells for RACH purposes. This is because the autocorrelation of a ZC sequence is ideal (they are CAZAC sequences by design) while the cross correlation of two root sequences is larger. Ideal autocorrelation means that the interference between the cyclically shifted sequences is nearly zero. In addition, if the base stations/Node B's of the different cells are not synchronized, the cyclic shifts of the same root sequence interfere strongly if they are allocated to the different cells.

These observations lead to a system where (in a typical case) a small number of different root sequences are dedicated in the neighboring cells, and additional sequences are obtained with cyclic shifts of these root sequences. The available cyclic shifts are obtained with the help of the parameter N_{cs} that the base station broadcasts and that is related to the cell size.

Essentially two different schemes have been proposed for allocation of cyclic shifts: maintaining as equal as possible number of cyclic shifts per root sequence (FIG. 3A) or concentrating the cyclic shifts in such a way that a clearly smaller number of sequences may be obtained from one of the used root sequences (FIG. 3B). The latter approach leads to smaller interference between the sequences but requires a larger set of N_{cs} values. The difference between these approaches is most pronounced if the cell size would allow small N_{cs}.

As an example, consider the case of N_{zc}=839. For the system of equal number of cyclic shifts, the two smallest N_{cs} values would be 13 and 26. These would mean spending one or two root sequences for the cell, and obtaining 64 or 32 cyclic shifts from the root sequences. For the system with unequal allocation, N_{cs} values between 13 and 26 would be needed. For instance, with N_{cs}=15, the set of 64 sequences would consists of 55 cyclic shifts from the first root sequence and 9 cyclic shifts from the second root sequence.

Keeping in mind the competing concerns noted above, what is needed is a better way to allocate and use the ZC root and cyclic shifts of it in a manner that will reduce the possibility of collisions and not overly burden the Node B with heavy processing loads.

### SUMMARY

In accordance with an exemplary embodiment of the invention is a method that includes receiving an allocation of a root sequence, determining from the received allocation all root sequences that are allocated in a cell for preamble signals, and selecting a sequence from among all cyclic shifts of all of the allocated root sequences, and sending on a random access channel an uplink transmission that includes a preamble signal with the selected sequence, wherein the number of all of the cyclic shifts is not limited to a predetermined minimum number of cyclic shifts that are to be available in the cell. All of the available cyclic shifts also includes the root sequence with a zero shift.

In accordance with another exemplary embodiment of the invention is a device that includes a receiver, a processor and a transmitter. The receiver is configured to receive an allocation of a root sequence and the processor is configured to determine from the received allocation all root sequences that are allocated in a cell for preamble signals. The processor is further configured to select a sequence from among all cyclic shifts of all of the allocated root sequences. And the transmitter is configured to send on a random access channel an uplink transmission that includes a preamble signal with the selected sequence. In the device, the number of all of the cyclic shifts is not limited to a predetermined minimum number of cyclic shifts that are to be available in the cell.

In accordance with another exemplary embodiment of the invention is a device that includes receive means (e.g., a receiver), processing means (e.g., a processor) and sending means (e.g., a transmitter). The receive means is for receiving an allocation of a root sequence. The processing means is for determining from the received allocation all root sequences that are allocated in a cell for preamble signals. The processing means is further for selecting a sequence from among all cyclic shifts of all of the allocated root sequences. And the sending means is for sending on a random access channel an uplink transmission that includes a preamble signal with the selected sequence. In this embodiment the number of all of the cyclic shifts is not limited to a predetermined minimum number of cyclic shifts that are to be available in the cell.

In accordance with yet another exemplary embodiment of the invention is a memory that embodies a program of computer readable instructions that when executed by a processor result in actions directed to determining cyclically shifted preamble signals. In this embodiment the actions include receiving an allocation of a root sequence and determining from the received allocation all root sequences that are allocated in the cell for use with preamble signals, and selecting a sequence from among all cyclic shifts of all of the allocated root sequences, and sending on a random access channel an uplink transmission that includes the selected sequence. In this embodiment the number of all of the cyclic shifts is not limited to a predetermined minimum number of cyclic shifts that are to be available in the cell.

In accordance with another exemplary embodiment of the invention is a method that includes receiving an allocation of all root sequences for use in a cell (where the allocation includes at least one root sequence), and sending an index that indicates at least one of the allocated root sequences and a basic cyclic shift parameter for use with the indicated root sequence, and receiving on a random access channel preamble signals that are shifted from among all available cyclic shifts of all of the allocated root sequences, where the number of all of the available cyclic shifts is not limited to a predetermined minimum number of cyclic shifts that are to be available in the cell.

In accordance with another exemplary embodiment of the invention is a device that includes a modem, a transmitter and a receiver. The modem is configured to receive an allocation of all root sequences for use in a cell, and the allocation has at least one root sequence. The transmitter is configured to send an index that indicates at least one of the allocated root sequences and a basic cyclic shift parameter for use with the indicated root sequence. And the receiver is configured to receive on a random access channel preamble signals that each include a sequence that has been selected from among all available cyclic shifts of all of the allocated root sequences, where the number of all of the available cyclic shifts is not limited to a predetermined minimum number of cyclic shifts that are to be available in the cell.

In accordance with another exemplary embodiment of the invention is a memory that embodies a program of computer readable instructions that when executed by a processor result in actions directed to distributing information about cyclical shifts that are available for use in a cell. In this embodiment the actions include receiving an allocation of all root sequences for use in a cell where the allocation includes at least one root sequence, and sending an index that indicates at least one of the allocated root sequences and a basic cyclic shift parameter for use with the indicated root sequence, and receiving on a random access channel preamble signals that each include a sequence that has been selected from among all available cyclic shifts of all of the allocated root sequences, where the number of all of the available cyclic shifts is not limited to a predetermined minimum number of cyclic shifts that are to be available in the cell.

In accordance with still another exemplary embodiment of the invention is a device that includes first receive means (e.g., a modem), sending means (e.g., a transmitter) and second receive means (e.g., a receiver). The first receive means is for receiving an allocation of all root sequence for use in a cell, and this allocation can be as little as one root sequence. The sending means is for sending an index that indicates at least one of the allocated root sequences and a basic cyclic shift parameter for use with the indicated root sequence. And the second receive means is for receiving on a random access channel preamble signals that each includes a sequence that has been selected from among all available cyclic shifts of all of the allocated root sequences, where the number of all of the available cyclic shifts is not limited to a predetermined minimum number of cyclic shifts that are to be available in the cell.

In accordance with yet another exemplary embodiment of the invention is a method that includes receiving in broadcast system information an index of a root sequence and a basic cyclic shift parameter N_{CS}, and determining from the received index a first root sequence that is allocated in a cell for preamble signals. Next, beginning with the root sequence indicated by the index and continuing as necessary for additional root sequences that are determined inherently from the index, calculating a number of available cyclic shifts (which includes a zero shift) from the basic cyclic shift parameter N_{CS} (or from the basic cyclic shift parameter N_{CS} in combination with the received index) and comparing the calculated number with a predetermined minimum number of cyclic shifts that are to be available in the cell. This continues/repeats through the additional root sequences as necessary until a total number of all cyclic shifts of respective root sequences at least equals the predetermined minimum number. In this manner it will be seen that such a predetermined minimum does not serve as an upward limit to the number of cyclic shifts from which the user equipment/mobile station selects. The method continues with selecting a sequence from among all cyclic shifts of all allocated root sequences, wherein all allocated root sequences consist of the root sequence indicated by the index and all of the additional root sequences that were treated above with the calculating and comparing. Further in the method is sent on a random access channel an uplink transmission that includes a preamble signal with the selected sequence. Responsive to sending the preamble signal, a user equipment becomes established in the cell.

### BRIEF DESCRIPTION OF THE DRAWINGS

Embodiments of the invention are detailed below with particular reference to the attached drawing Figures.

FIG. 1A reproduces FIG. 15 at section 6.7.1 of 3GPP TS 36.211 (V1.0.0), showing a recently-adopted RACH preamble format (generic) for the 3GPP LTE UL.

FIG. 1B shows the generation of a RACH preamble signal according to section 6.7.2 of 3GPP TS 36.211 V.1.0.0.

FIG. 2 shows high-level schematic block diagrams of apparatus in which embodiments of the invention may be implemented.

FIG. 3A is a prior art arrangement illustrating an equal number of cyclic shifts for each of two root sequences in order to achieve the mandated 64 ZC sequences in use in the cell.

FIG. 3B is a prior art arrangement illustrating a maximum number of cyclic shifts for a first root sequence and a minimum number of cyclic shifts for a second root sequence so that the total equals the mandated 64 ZC sequences in use in the cell.

FIG. 4 is a schematic diagram similar in form to FIGS. 3A-3B, but showing an embodiment of this invention wherein all available cyclic shifts for both allocated ZC root sequences are used in the cell.

FIG. 5 is a diagram of method steps executed by the various nodes of FIG. 2 according to one exemplary embodiment of the invention.

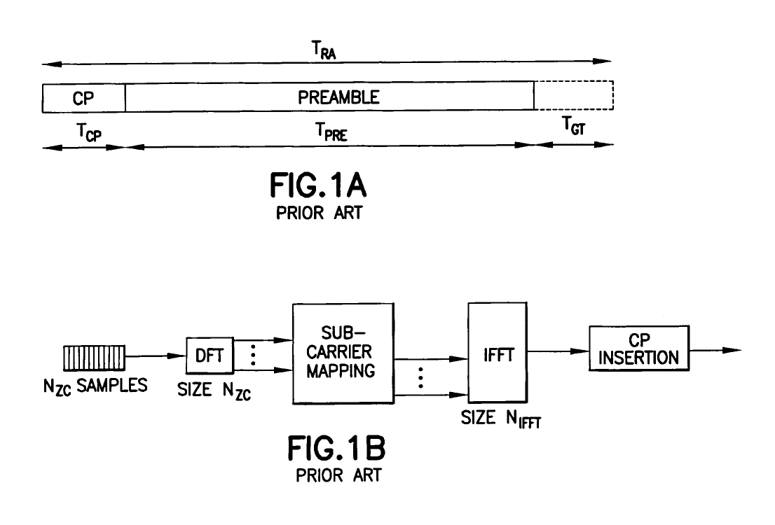

### DETAILED DESCRIPTION

Several recent proposals on sequence allocation have been advanced (see for example 3GPP R1-072325, R1-072192, and R1-072079, attached to priority document U.S. 60/933,732). One common factor underlying each of those three proposals is that they each assume a fixed number of sequences per cell. But as noted above the number of cyclic shifts allowed is dependent upon cell size, and assuming a fixed number of sequences per cell is inherently an allocation that is independent of N_{cs}. As will be seen in embodiments of this invention detailed below, the total number of sequences (root sequences+their cyclic shifts) allocated for one cell is allowed to vary in such a way that all the possible cyclic shifts of each root sequence are always utilized/available in the cell.

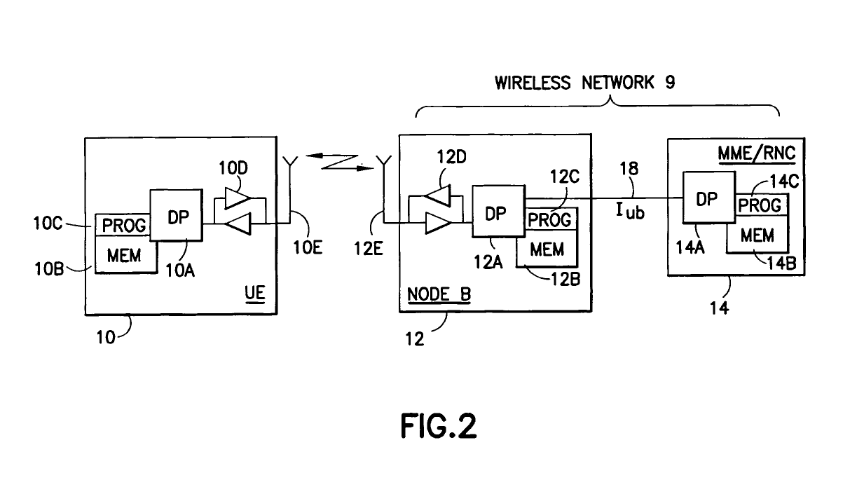

Reference is now made to FIG. 2 for illustrating a simplified block diagram of various electronic devices that are suitable for use in practicing the exemplary embodiments of this invention. In FIG. 2 a wireless network 9 is adapted for communication with a UE 10 via a Node B (base station) 12. The network 9 may include a serving mobility management entity MME/radio network controller RNC 14 or other radio controller function known by various terms in different wireless communication systems. The UE 10 includes a data processor (DP) 10A, a memory (MEM) 10B that stores a program (PROG) 10C, and a suitable radio frequency (RF) transceiver 10D coupled to one or more antennas 10E (one shown) for bidirectional wireless communications with the Node B 12, which also includes a DP 12A, a MEM 12B that stores a PROG 12C, and a suitable RF transceiver 12D coupled to one or more antennas 12E. The Node B 12 may be coupled via a data path 18 (e.g., lub) to the serving or other MME/RNC 14. The MME/RNC 14 includes a DP 14A, a MEM 14B that stores a PROG 14C, and a suitable modem and/or transceiver (not shown) for communication with the Node B 12 over the lub link 18.

Also within the network 9 are other Node Bs (not shown) in neighbor (adjacent) cells, and multiple UEs under the control of each of the individual Node Bs. Some neighbor Node Bs are under control of a common MME/RNC, in which case the MME/RNC itself allocates the appropriate ZC root sequences to the Node Bs for use by the UEs in their cell. In other instances one Node B is under control of one MME/RNC and a neighboring Node B is under control of another MME/RNC, in which case some coordination among the various MMEs/RNCs is necessary for an allocation to the neighboring Node Bs that will best avoid collisions. At least one of the PROGs 10C, 12C and 14C is assumed to include program instructions that, when executed by the associated DP, enable the electronic device to operate in accordance with the exemplary embodiments of this invention, as will be discussed below in greater detail. Inherent in the DPs 10A, 12A, and 14A is a clock to enable synchronism among the various apparatus for transmissions and receptions within the appropriate time intervals and slots required.

The PROGs 10C, 12C, 14C may be embodied in software, firmware and/or hardware, as is appropriate. In general, the exemplary embodiments of this invention may be implemented by computer software stored in the MEM 10B and executable by the DP 10A of the UE 10 and similar for the other MEMs and DPs, or by hardware, or by a combination of software and/or firmware and hardware in any or all of the devices shown.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B and 12B may be of any type suitable to the local technical environment and may be implemented using any suitable data storage technology, such as semiconductor-based memory devices, magnetic memory devices and systems, optical memory devices and systems, fixed memory and removable memory. The DPs 10A and 12A may be of any type suitable to the local technical environment, and may include one or more of general purpose computers, special purpose computers, microprocessors, digital signal processors (DSPs) and processors based on a multi-core processor architecture, as non-limiting examples.

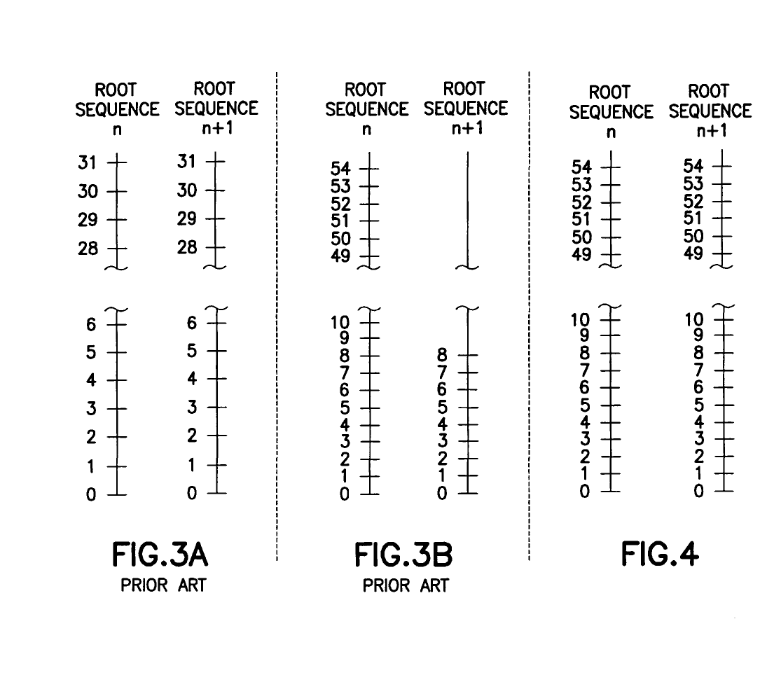

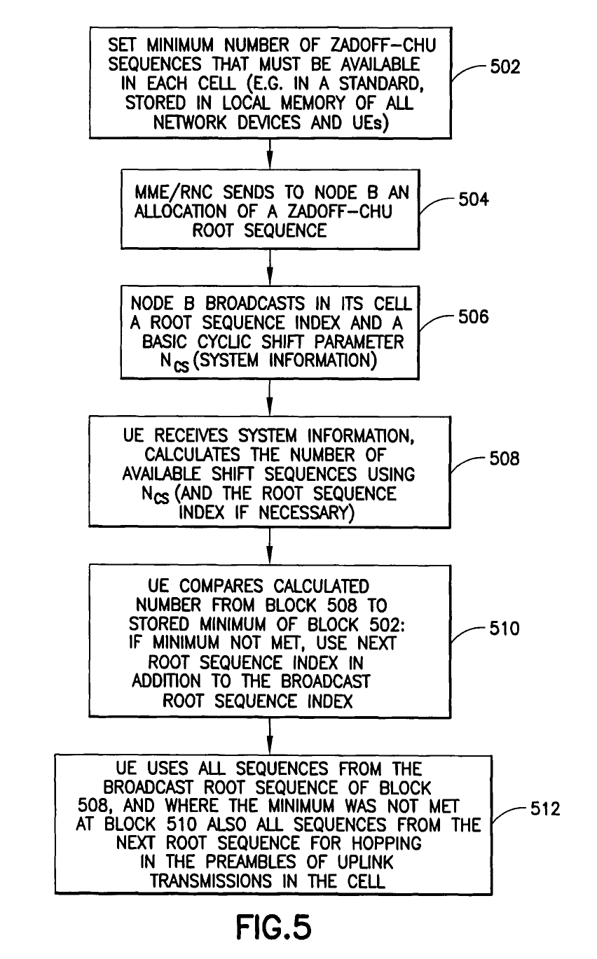

As noted above, for exemplary embodiments of this invention the total number of sequences (root sequences+their cyclic shifts) allocated for one cell is allowed to vary in such a way that all the possible cyclic shifts of each root sequence are always utilized. Consider again the prior art schemes of FIGS. 3A-3B as compared to the diagram of FIG. 4 illustrating one embodiment of the invention. In the case where there is uncertainty in the propagation delay corresponding to N_{cs}=15, a maximum of 55 total sequences can be made available for each ZC root, due to that uncertainty. Recall the above-noted agreement that there will be 64 sequences available in each cell. This means that there must be at least two ZC root sequences allocated to each cell, since the uncertainty mandates that no single ZC root and its cyclic shifts can satisfy the 64 criteria. The numbers in FIGS. 3A-3B and 4 indicate the sequences that are actually used (0 indicates the root sequence; other numbers indicate a shift of that root sequence). For each of those prior art FIGS. 3A-3B, there are a total of 64 sequences allocated among two root ZC sequences, root sequence n and root sequence n+1. At FIG. 3A, there are 32 sequences from each of the two roots. At FIG. 3B, there are the maximum number 55 sequences from the first root and only 9 sequences from the second root. But at FIG. 4 using those same two root sequences, there are a total of 110 sequences, 55 for each of the two roots. This is because all cyclic shifts for all ZC root sequences are allocated for use in the cell in which those ZC root sequences are allocated.

In FIG. 4 all of the available cyclic shifts are available in the cell and used. In FIGS. 3A-3B, only the mandated number of cyclic shifts 64 are used, leaving other unused cyclic shifts as wasted resources. The approach of FIG. 3A minimizes the number of broadcasted System Information bits because fewer N_{cs} options are available to the UEs in the cell. The approach of FIG. 3B exhibits some improvement over FIG. 3A in the sense that interference is minimized because the used sequences are concentrated to fewer root sequences (in this example to one root sequence). But the approach of FIG. 4 is an improvement over both, because the rate of preamble collisions is reduced due to the greater number of cyclic shifts actually being used by the UEs in the cell.

One way to implement this embodiment is in a standard (3GPP TS) that defines only the minimum number of sequences that must be available for each cell. This minimum number can be for instance 64. The broadcasted System Information of the cell contains a root sequence index and the basic cyclic shift parameter N_{cs}. The UE in the cell receives that System Information on a broadcast downlink channel, and from it calculates the available cyclic shifts using N_{cs} (or the root sequence index and N_{cs} in case of the more complex system of high mobility UEs). If the number of cyclic shifts obtained from the root sequence is smaller than the minimum number, the UE continues with the cyclic shifts of the next root index. This can be readily implemented in UE software stored in the MEM 10C. Unlike the approaches of FIG. 3B, that number of shifts from that next index is not truncated once the set number 64 is reached, but all cyclic shifts for that next root index are used. This continues for however many root sequences are allocated to the cell. Thus the UE selects the sequence that it sends on the preamble transmission from among all cyclic shifts of all root sequences that are allocated in the cell (where the term ‘all cyclic shifts’ for any root sequence includes a zero shift which is simply the unshifted root sequence). If as above the standard only defines a minimum number rather than a fixed number of shifts that must be made available in the cell, the number of available cyclic shifts from which the UE selects its sequence is not limited to that predetermined minimum number in the standard.

Using the numbers of the example given in the background section for FIGS. 3A-3B, if the cell size allowed N_{cs}=15, two root sequences with 55 cyclic shifts, then a total of 110 sequences would be available for the cell. Defining N_{cs} less than 13 would mean that more than 64 sequences would be available from a single root sequence.

One advantage of these embodiments of the invention is that the number of sequences per cell would be maximized, meaning minimization of the preamble collision probability, without any complexity increase for the UE 10 and essentially no complexity increase in the base station/Node B receiver 12D. The UE 10 calculates the cyclically shifted sequence on the fly so that the number or size of cyclic shifts does not make any difference. On the fly calculation is seen as a more efficient implementation because storing of the sequences themselves would consume more memory than is seen as prudent. The simplest base station/Node B receiver 12D detects sequences using frequency domain correlation. Then the factor defining the processing load is the number of root sequences: all the cyclically shifted sequences of a root sequence can be detected simultaneously.

The frequency domain correlation means that first a DFT is calculated over the received signal. Then the output of the DFT is multiplied by the complex conjugate of the root sequence and this product is then processed with an IDFT. From the output of the IDFT, the appearance of correlation peaks is checked at the delays corresponding to the cyclic shifts of the root index. The processing load is mainly due to the DFT, IDFT, and multiplication of the sequences. Only the last checking noted above, which is a very minor part of the total processing load, can be simplified if a part of the cyclic shifts, allowed by the cell size, need not be checked.

Now, full utilization of this invention might encompass increasing the size of the System Information that is currently agreed to in LTE, but only by a few bits. Because the total number of sequences would be increased, in one embodiment one additional bit is used to indicate the division of sequences in two groups (that kind of grouping has been agreed in 3GPP), and one or two bits are used because of the additional N_{cs} values. Adding these bits would have a very small effect to the downlink capacity of the system. In any case, the RACH related system information would consist of about 20 bits. RACH related system information is only a small part of the total (frequently transmitted) System Information, and a small part of the whole capacity is spent for the System Information.

FIG. 5 is a series of process steps executed by the various nodes shown in FIG. 2 for operating according to an embodiment of the invention detailed above. At block 502 is set a minimum number of Zadoff-Chu sequences for use in each cell. As noted above, this may be stipulated in a standard, in which case it would be stored in the local memory of each of the RNC 14, Node B 12 and UE 10 well prior to the signalling detailed further in FIG. 5. Each of these devices would also have stored each of the root Zadoff-Chu sequences, and an index number associated with each. The index number is used for signalling as opposed to sending the entire ZC root sequence being allocated or in use, and as noted above the UEs 10 (and the Node B 12) may store also the cyclic shifts of the ZC sequences but more efficiently compute these on the fly as they are needed in any particular preamble. At block 504 the MME/RNC 14 sends via the lub link 18 to the Node B 12 the Zadoff-Chu root sequence(s) that it is being allocated. Since that link 18 may be wired or wireless, the actual root sequence or the index may be sent. The MME/RNC 14 ensures no adjacent cell is allocated the same ZC root sequence.

Now at block 506 the Node B 12 sends on the downlink, such as broadcast in the System Information, the index for the ZC root sequence it is allocated. If the Node B is allocated two or more root sequences, it need only broadcast the index for the first one (so long as the allocated sequences are in order n, n+1, n+2, etc.). In this manner the UE 10 will know whether to roll over to the next ZC root sequence as will be seen at block 510. Alternatively, the Node B 12 can broadcast each index of a ZC root sequence that it has been allocated for use in the cell. With the root sequence index, the Node B 12 also broadcasts the basic cyclic shift parameter (e.g., N_{CS}) for that ZC root sequence.

At block 508 the UE 10 receives the System Information of block 506, and uses the basic cyclic shift parameter N_{CS} to calculate the number of available shift sequences, such as by the equation noted above S_{k,v}(n)=S_{k,0}(mod(n+v*N_{cs},N_{zc})). For more complex systems supporting high velocity UEs, the UE 10 may also need to use the root sequence index for this calculation.

At block 510 the UE 10 then compares the number of available cyclic shift sequences calculated at block 508 against the stored minimum number that must be available in the cell from block 502. If the block 510 value exceeds the block 502 minimum, then all of those calculated shift sequences, including the root sequence, are used by the UE 10 in hopping for the various preambles is sends on the uplink. If instead the calculated value from block 510 is less than the block 502 minimum, then the UE 10 knows that it must use the next root sequence in order to obtain its full set of shift sequences for use in the cell.

At block 512, the UE 10 uses all of the sequences from the broadcast root ZC sequence index, as well as all of the sequences for the next-indexed root sequence if use of that additional root was necessary at block 510 to exceed the minimum of block 502, for hopping to determine the ZC sequence to use in any of the preambles it sends to the Node B 12 on the uplink. This is not to say that the UE transmits each and every cyclic shift of each and every root sequence that is allocated in the cell. Rather the UE selects one sequence (root and shift, where a zero shift is also an option) from among all root sequences available in the cell and all cyclic shifts of all of those root sequences and transmits that selected sequence. This is of course limited by the network-defined cyclic shifts, which in the prior art are fully defined but certain of them are denied use in the cell so as not to exceed some predetermined number (e.g., 64) that must be made available. According to these teachings that predetermined number may be stipulated as a minimum rather than fixed for all cells. Similarly, the Node B receives preambles from multiple different UEs, each of which has made its selection for their respective preamble from among all root sequences available in the cell and all cyclic shifts of all of those root sequences.

An example of N_{cs} values and the corresponding number of sequences is given in Table 1. The number of sequences has been calculated for the system of FIG. 5 assuming 64 as the minimum number of sequences and N_{zc}=839. The 15 underlined N_{cs} values have been proposed for the prior art system of FIG. 3A, and they are obtained applying two rules: (1) each N_{cs} value must correspond to a different number of root sequences, and (2) the largest of the N_{cs} values corresponding to the same number of root sequences is selected. Broadcasting one of these 15 N_{cs} values would then call for four bits in the System Information. If one more bit were allowed, 32 N_{cs} values could be signaled and the invented method would be used effectively. The smallest N_{cs} value has been selected such that the total number of sequences is always less than 128. Then seven bits would be reserved in the system information for indicating the division of the signatures into the two groups. If the number of sequences were limited to 64, six bits would be spent for indicating the division.

TABLE 1

| | Number | Number of | |
|---|---|---|---|
| | of cyclic | root | Number of |
| Nsc | shifts | sequences | sequences |
| 7 | 119 | 1 | 119 |
| 8 | 104 | 1 | 104 |
| 9 | 93 | 1 | 93 |
| 10 | 83 | 1 | 83 |
| 11 | 76 | 1 | 76 |
| 13 | 64 | 1 | 64 |
| 15 | 55 | 2 | 110 |
| 17 | 49 | 2 | 98 |
| 20 | 41 | 2 | 82 |
| 23 | 36 | 2 | 72 |
| 26 | 32 | 2 | 64 |
| 27 | 31 | 3 | 93 |
| 29 | 28 | 3 | 84 |
| 32 | 26 | 3 | 78 |
| 34 | 24 | 3 | 72 |
| 36 | 23 | 3 | 69 |
| 38 | 22 | 3 | 66 |
| 41 | 20 | 4 | 80 |
| 46 | 18 | 4 | 72 |
| 52 | 16 | 4 | 64 |
| 55 | 15 | 5 | 75 |
| 64 | 13 | 5 | 65 |
| 76 | 11 | 6 | 66 |
| 83 | 10 | 7 | 70 |
| 104 | 8 | 8 | 64 |
| 119 | 7 | 10 | 70 |
| 139 | 6 | 11 | 66 |
| 167 | 5 | 13 | 65 |
| 209 | 4 | 16 | 64 |
| 279 | 3 | 22 | 66 |
| 419 | 2 | 32 | 64 |
| 839 | 1 | 64 | 64 |

In accordance with the described exemplary embodiments of the invention, there is provided with respect to the user equipment device a computer program embodied on a computer readable memory and executable by a processor, a method and an apparatus configured to receive from a network node a root sequence allocated for preamble signals to be used in the cell, and to use all available cyclic shifts of that allocated root sequence for determining the preamble signals to use in the cell, and thereafter to send uplink transmissions in the cell on a random access channel that include cyclically shifted preamble signals. Particular embodiments are shown in FIG. 5, such as where the receiving is over a broadcast channel, where the received information is System Information that includes an index of an allocated root sequence and a basic cyclic shift parameter N_{CS}, where there is further a calculation of the number of available cyclic shifts from the basic cyclic shift parameter and then a comparison of that number against a predetermined minimum number of cyclic shifts that are to be available in the cell.

In accordance with the described exemplary embodiments of the invention, there is provided with respect to the network node/Node B device a computer program embodied on a computer readable memory and executable by a processor, a method and an apparatus configured to receive an allocation of at least one root reference signal for use in its cell, and to thereafter broadcast an index for that allocated reference signal and a basic cyclic shift parameter for use with that allocated root reference signal on a random access channel.

Further, while described in the context of LTE and ZC sequences, it is within the scope of the exemplary embodiments of this invention to use the above described UE 10 and Node-B 12 procedures for other types of wireless communication systems that employ cyclic shifting of other reference signals that are randomized by cyclic shifting.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

1-31. (canceled)

32. A method comprising:
receiving an allocation of a root sequence;
determining from the received allocation all root sequences that are allocated in a cell for preamble signals;
selecting a sequence from among all cyclic shifts of all of the allocated root sequences; and
sending on a random access channel an uplink transmission that comprises a preamble signal with the selected sequence;
wherein a number of the all cyclic shifts is not limited to a predetermined minimum number of cyclic shifts that are to be available in the cell.

33. The method of claim 32, wherein the allocation of the root sequence is received over a broadcast channel from a network node.

34. The method of claim 33, wherein the allocation of the root sequence is received in system information that comprises an index of at least one allocated root sequence and a basic cyclic shift parameter N_{CS},

35. The method of claim 34, wherein the allocation comprises an index of only one allocated root sequence and all of the other root sequences that are allocated in the cell for preamble signals are inherently indicated by the index.

36. The method of claim 34, further comprising:
calculating a number of available cyclic shifts from the basic cyclic shift parameter N_{CS} or from the basic cyclic shift parameter N_{CS} in combination with the root sequence index and comparing the calculated number with the predetermined minimum number and if the calculated number is not at least equal to the predetermined minimum number, then repeating for a next one of the root sequences that are allocated in the cell the calculating and comparing until a total number of all cyclic shifts of respective root sequences at least equals the predetermined minimum number.

37. A device comprising:
a receiver configured to receive an allocation of a root sequence;
a processor configured to determine from the received allocation all root sequences that are allocated in a cell for preamble signals, and to select a sequence from among all cyclic shifts of all of the allocated root sequences; and
a transmitter configured to send on a random access channel an uplink transmission that comprises a preamble signal with the selected sequence;
wherein the number of the all cyclic shifts is not limited to a predetermined minimum number of cyclic shifts that are to be available in the cell.

38. The device of claim 37, wherein the allocation of the root sequence is received over a broadcast channel from a network node.

39. The device of claim 38, wherein the allocation of the root sequence is received in system information that comprises an index of at least one allocated root sequence and a basic cyclic shift parameter N_{CS},

40. The device of claim 39, wherein the allocation comprises an index of only one allocated root sequence and all of the other root sequences that are allocated in the cell for preamble signals are inherently indicated by the index.

41. The device of claim 39, wherein the processor is further configured to calculate the number of available cyclic shifts from the basic cyclic shift parameter N_{CS} or from the basic cyclic shift parameter N_{CS} in combination with the root sequence and to compare the calculated number with the predetermined minimum number and if the calculated number is not at least equal to the predetermined minimum number, then to repeat for a next one of the root sequences that are allocated in the cell the calculating and comparing until a total number of cyclic shifts of respective root sequences at least equals the predetermined minimum number.

42. The device of claim 37, wherein the device comprises a user equipment.

43. A method comprising:
receiving an allocation of all root sequences for use in a cell, wherein the allocation comprises at least one root sequence;
sending an index that indicates at least one of the allocated root sequences and a basic cyclic shift parameter for use with the indicated root sequence on a random access channel; and
receiving on a random access channel preamble signals that comprise sequences that have been selected from among all available cyclic shifts of all of the allocated root sequences;
wherein the number of all of the available cyclic shifts is not limited to a predetermined minimum number of cyclic shifts that are to be available in the cell.

44. The method of claim 43, wherein the received allocation is for a plurality of root sequences and the sending comprises broadcasting in system information an index for only one of the plurality of allocated root sequences and the basic cyclic shift parameter.

45. The method of claim 43 executed by a Node B.

46. A device comprising:
a modem configured to receive an allocation of all root sequences for use in a cell, wherein the allocation comprises at least one root sequence;
a transmitter configured to send an index that indicates at least one of the allocated root sequences and a basic cyclic shift parameter for use with the indicated root sequence; and
a receiver configured to receive on a random access channel preamble signals that comprise sequences that have been selected from among all available cyclic shifts of all of the allocated root sequences;
wherein the number of all of the available cyclic shifts is not limited to a predetermined minimum number of cyclic shifts that are to be available in the cell.

47. The device of claim 46, wherein the received allocation is for a plurality of root sequences and the transmitter is configured to broadcast in system information the index for only one of the allocated root reference signals and the basic cyclic shift parameter.

48. The device of claim 46 wherein the device comprises a Node B.

49. A method comprising:
receiving in broadcast system information an index of a root sequence and a basic cyclic shift parameter N_{CS};
determining from the received index a first root sequence that is allocated in a cell for preamble signals;
beginning with the root sequence indicated by the index and continuing as necessary for additional root sequences that are determined inherently from the index, calculating a number of available cyclic shifts from the basic cyclic shift parameter N_{CS} or from the basic cyclic shift parameter N_{CS} in combination with the received index and comparing the calculated number with a predetermined minimum number of cyclic shifts that are to be available in the cell until a total number of all cyclic shifts of respective root sequences at least equals the predetermined minimum number;
selecting a sequence from among all cyclic shifts of all allocated root sequences, wherein all allocated root sequences consist of the root sequence indicated by the index and all of the additional root sequences; and
sending on a random access channel an uplink transmission that comprises a preamble signal with the selected sequence; and
responsive to sending the preamble signal, establishing a user equipment in the cell.
